(19) United States
(12) Patent Application Publication
(10) Pub. No.: US 2026/0275173 A1
(43) Pub. Date: Sep. 17, 2026

(54) HOT-MELT ADHESIVE COMPOSITION, PRECOATED SURFACE MATERIAL FOR AUTOMOBILE INTERIOR, AUTOMOBILE INTERIOR MATERIAL, AND METHOD OF PRODUCING BONDED BODY

(71) Applicant: Sunstar Engineering Inc., Osaka (JP)

(72) Inventor: Hideyuki KOYANAGI, Osaka (JP)

(73) Assignee: Sunstar Engineering Inc., Osaka (JP)

(21) Appl. No.: 19/564,072

(22) Filed: Mar. 11, 2026

(30) Foreign Application Priority Data
Mar. 12, 2025 (JP) 2025-039092

(51) Int. Cl. C09J 123/14; C09J 5/06; C09J 11/08; C09J 123/20

(52) U.S. Cl. CPC C09J 123/142; C09J 5/06; C09J 11/08; C09J 123/20

(57) ABSTRACT

The present disclosure is to provide a hot-melt adhesive composition which exhibits good adhesion to a resin substrate, such as a polyolefin substrate formed of a polypropylene or the like, and can achieve both a long open time and a high heat resistance, despite being a non-reactive hot-melt adhesive composition. Provided is a hot-melt adhesive composition comprising: a crystalline α-olefin copolymer (A) having a Shore A hardness of 80 or more; a tackifier (B); and a plasticizer (C). In the viscoelastic behavior of the hot-melt adhesive composition when rapidly cooled from 170° C. to 20° C. at a rate of 30° C./min and then maintained at 20° C., the hot-melt adhesive composition has a storage elastic modulus (G′) of 3.3×10⁵ Pa or less as measured at a time of 3 minutes after reaching 20° C. (measurement time: 8 minutes) at a frequency of 1 Hz.

### CROSS REFERENCE TO RELATED APPLICATION

This application claims benefit of priority to Japanese Patent Application 2025-039092, filed Mar. 12, 2025, the entire content of which is incorporated herein by reference.

### BACKGROUND

### Technical Field

The present disclosure relates to: a hot-melt adhesive composition; a precoated surface material for automobile interior, which comprises the same; and an automobile interior material.

### Background Art

Hot-melt adhesives, which are solid at room temperature, are heat-melted, applied to substrates, and then solidified by cooling to bond the substrates together. Such hot-melt adhesives are advantageous over solvent-based adhesives in terms of productivity improvement and the like through reduction in VOC (volatile organic compounds) and omission of drying process, and are thus used in various applications such as automobile production.

Automobile interior materials, such as door trims, instrument panels, headliners, rear trays, and pillars, are generally composed of a molded article and a surface material. As the molded article, a polyolefin molded article or an ABS molded article is mainly used. Meanwhile, as the surface material, a surface material formed of a polyolefin foam-lined soft polyvinyl chloride, a polyolefin foam-lined olefin-based thermoplastic elastomer, a polyurethane foam-lined fabric, or the like is used. The molded article and the surface material are bonded via an adhesive generally by a vacuum molding process, a compression molding process, or the like.

In recent years, from the standpoint of recycling, monomaterialization of automobile interior materials has been studied, and configurations in which a polyolefin molded body and a polyolefin foam-lined olefin-based thermoplastic elastomer are bonded together using a polyolefin-based hot-melt adhesive have been widely examined. Standardization of automobile interior materials with polyolefins is expected to improve the productivity through elimination of the step of disassembling the parts and the step of removing foreign components incompatible with polyolefin components.

As hot-melt adhesive compositions for vacuum molding process, the following hot-melt adhesive compositions of Patent Documents 1 and 2 can be exemplified.

Patent Document 1 discloses a hot-melt adhesive composition that contains a crystalline polyolefin, an amorphous polyolefin, and a polypropylene wax.

Patent Document 2 discloses a hot-melt adhesive composition that contains an α-olefin copolymer polymerized using a multi-site catalyst, an α-olefin copolymer polymerized using a single-site catalyst, an ethylene-polar group-containing monomer copolymer, a hydrogenated tackifier resin, and a polypropylene wax.

As hot-melt adhesive compositions for compression molding process, the following hot-melt adhesive compositions of Patent Documents 3 and 4 can be exemplified.

Patent Document 3 discloses a hot-melt adhesive composition that contains a 1-butene homopolymer, an α-olefin copolymer having a melting point of 90° C. or higher, a tackifier resin, a polypropylene wax, and a liquid hydrocarbon.

Patent Document 4 discloses a hot-melt adhesive composition that contains a 1-butene homopolymer, an α-olefin copolymer having a melting point of 90° C. or higher, a tackifier resin having a softening point of 125° C. or higher, a polypropylene wax, and a liquid hydrocarbon.
Patent Document 1: JP 2024-004788 A
Patent Document 2: JP 6810898 B
Patent Document 3: JP 7095682 B
Patent Document 4: JP 6304405 B

### SUMMARY

In a compression molding process, it is necessary to set a long time (open time) after melting and applying a hot-melt adhesive to a substrate (e.g., a surface material) till pasting the substrate with an adherend (e.g., a molded body). For example, in the case of a large-sized molded body such as a door trim, it takes time to set up prior to compression molding, which includes aligning the molded body and the surface material; therefore, it is more preferred to have an open time of, for example, about 3 minutes from the standpoint of workability and yield. When the surface material is a fabric material and the open time is short (e.g., about 1 minute), since a hot-melt adhesive composition applied to the fabric surface is pressed in a state where the temperature of the hot-melt adhesive composition is high, defects in the outer appearance of the fabric surface, such as fiber collapse and surface irregularities, can occur, which is not preferred.

Automobile interior materials produced by bonding a surface material and a molded body are required to have a high heat resistance; therefore, a hot-melt adhesive composition needs to have a high heat resistance. Generally, a long open time and a high heat resistance are contradictory properties, and it is normally difficult to achieve a long open time and a high heat resistance in a hot-melt adhesive composition. A reactive hot-melt adhesive composition using a silane-modified polyolefin or the like can achieve both a long open time and a high heat resistance; however, such a reactive hot-melt adhesive composition has problems of, for example, insufficient storage stability and long curing time. In addition, the reactive hot-melt adhesive composition has a problem in that it can generate VOCs since it releases alcohols in the process of moisture curing reaction.

In Patent Documents 1 and 2 that relate to hot-melt adhesive compositions for vacuum molding process, the open time is substantially about 10 seconds, which is not considered sufficient for application to a compression molding process.

In Patent Documents 3 and 4 that disclose hot-melt adhesive compositions for a compression molding process, the hot-melt adhesive compositions are applied to a substrate and then re-activated, and the open time is substantially about 45 seconds, which is not sufficiently long (see, for example, [0057] of Patent Document 3 and [0038] of Patent Document 4).

Further, in both of Patent Documents 1 and 2, evaluations are made based on a process in which a surface material (precoated surface material) coated with each hot-melt adhesive composition is pasted after being heat-melted again by a far-infrared heater or the like, i.e., re-activation, however evaluations are not made based on a process in which a hot-melt adhesive composition is applied to a surface material and then pasted after an open time without re-activation (which is thought to be a proper compression molding process).

In view of the above, an object of the present disclosure is to provide a hot-melt adhesive composition which exhibits good adhesion (or adhesiveness) to, for example, a resin substrate such as a polyolefin substrate formed of a polypropylene or the like, and can achieve both a long open time and a high heat resistance, despite being a non-reactive hot-melt adhesive composition. Another object of the present disclosure is to provide a hot-melt adhesive composition that can be used in a process (e.g., a compression molding process) in which the hot-melt adhesive composition is applied to a surface material and, without re-activation of the composition, the resulting surface material is subsequently pasted together with a molded body after a long open time. Yet another object of the present disclosure is to provide a hot-melt adhesive composition that can be suitably used for automobile interior.

That is, the present disclosure encompasses the following embodiments.

<1> A hot-melt adhesive composition, comprising:
a crystalline α-olefin copolymer (A) having a Shore A hardness of 80 or more;
a tackifier (B); and
a plasticizer (C),
wherein, in the viscoelastic behavior of the hot-melt adhesive composition when rapidly cooled from 170° C. to 20° C. at a rate of 30° C./min and then maintained at 20° C., the hot-melt adhesive composition has a storage elastic modulus (G′) of 3.3×10⁵ Pa or less as measured at a time of 3 minutes after reaching 20° C. (measurement time: 8 minutes) at a frequency of 1 Hz.
   <2> The hot-melt adhesive composition according to <1>, wherein the α-olefin copolymer (A) comprises at least one selected from the group consisting of an ethylene-propylene copolymer and a propylene-butene copolymer.
   <3> The hot-melt adhesive composition according to <1> or <2>, wherein the α-olefin copolymer (A) is polymerized using a single-site catalyst.
   <4> The hot-melt adhesive composition according to any one of <1> to <3>, wherein the tackifier (B) has a softening point of 100° C. or higher.
   <5> The hot-melt adhesive composition according to any one of <1> to <4>, wherein the tackifier (B) comprises at least one selected from the group consisting of a hydrogenated petroleum resin, a terpene resin, and a terpene phenol resin.
   <6> The hot-melt adhesive composition according to any one of <1> to <5>, wherein the plasticizer (C) comprises at least one selected from the group consisting of a liquid butene oligomer and a liquid ethylene-propylene oligomer.
   <7> The hot-melt adhesive composition according to any one of <1> to <6>, comprising a polypropylene-based wax (D).
   <8> The hot-melt adhesive composition according to any one of <1> to <7>, comprising a polyolefin-based elastomer (E).
   <9> The hot-melt adhesive composition according to any one of <1> to <8>, comprising an antioxidant (F).
   <10> The hot-melt adhesive composition according to any one of <1> to <9>, having a melt viscosity of 100,000 mPa·s or less at 180° C.
   <11> The hot-melt adhesive composition according to any one of <1> to <10>, which is for an automobile interior material.
   <12> A precoated surface material for automobile interior, comprising:
a surface material for automobile interior; and
a hot-melt adhesive layer formed from the hot-melt adhesive composition according to any one of <1> to <11> on a back surface of the surface material for automobile interior.
   <13> An automobile interior material, comprising:
a molded article for automobile interior; and
the precoated surface material for automobile interior according to <12>, which is bonded to the molded article for automobile interior via the hot-melt adhesive layer.
   <14> A method of producing a bonded body,
wherein
the bonded body comprises a first substrate, and a second substrate bonded to the first substrate via a hot-melt adhesive layer formed from the hot-melt adhesive composition according to any one of <1> to <11>, and
the method comprises a step of melting and applying the hot-melt adhesive composition according to any one of <1> to <11> onto the first substrate, and subsequently bonding the second substrate thereto within 3 minutes.

The hot-melt adhesive composition of the present disclosure exhibits good adhesion (or adhesiveness) to, for example, a polyolefin substrate formed of a polypropylene or the like, and can achieve both a long open time and a high heat resistance, despite being a non-reactive hot-melt adhesive composition. Further, the hot-melt adhesive composition of the present disclosure can be, without re-activation, suitably used in a process (e.g., a compression molding process) in which the hot-melt adhesive composition is applied to a surface material and then pasted together with a molded body after an open time of, for example, about 3 minutes, and can also be suitably used as an adhesive for automobile interior.

### DETAILED DESCRIPTION

### <Hot-Melt Adhesive Composition>

The hot-melt adhesive composition of the present disclosure comprises a crystalline α-olefin copolymer (A) having a Shore A hardness of 80 or more (hereinafter, also referred to as “α-olefin copolymer (A)”), a tackifier (B), and a plasticizer (C). In addition to (A) to (C), if necessary, the hot-melt adhesive composition of the present disclosure may further comprise one or more selected from a polypropylene-based wax (D), a polyolefin-based elastomer (E), an antioxidant (F), an inorganic filler (G), other additives, and the like.

### [(A) Crystalline α-Olefin Copolymer Having Shore A Hardness of 80 or More]

The hot-melt adhesive composition of the present disclosure contains a crystalline α-olefin copolymer (A) having a Shore A hardness of 80 or more. Further, the α-olefin copolymer (A) may be characterized by, for example, crystallinity and/or molecular weight. Typically, the α-olefin copolymer (A) has a crystallinity of 20% or more. Typically, the α-olefin copolymer (A) has a weight-average molecular weight of, for example, 40,000 or more.

The crystallinity of the α-olefin copolymer (A) may be 20% or more, 25% or more, 30% or more, or 35% or more. The crystallinity of the α-olefin copolymer (A) may be 100% or less, 98% or less, 95% or less, 90% or less, or 85% or less. The crystallinity is preferably 20% or more from the standpoint of allowing the effects of the present disclosure to be exerted more favorably. The crystallinity can be measured by, for example, differential scanning calorimetry. The term “crystalline” used herein may mean a property that a clear endothermic peak derived from a crystal portion is observed in differential scanning calorimetry, while the term “amorphous” used herein may mean a property that a clear endothermic peak derived from a crystal portion is not observed in differential scanning calorimetry.

The Shore A hardness of the α-olefin copolymer (A) may be 80 or more, 85 or more, 90 or more, or 95 or more, and it is preferably 85 or more, more preferably 90 or more. The Shore A hardness of the α-olefin copolymer (A) may be 100 or less, 99 or less, 98 or less, or 97 or less. The Shore A hardness may be used as an index of the cohesive strength of a resin, and can serve as one of indices of the adhesion at room temperature and in a hot state. The Shore A hardness is preferably in a range of 85 to 100 from the standpoint of allowing the effects of the present disclosure to be exerted more favorably. The Shore A hardness can be measured in accordance with the method prescribed in JIS K6253-3:2012 (Rubber, vulcanized or thermoplastic—Determination of hardness).

The melting point of the α-olefin copolymer (A) may be 80° C. or higher, 90° C. or higher, 100° C. or higher, or 110° C. or higher, and it is preferably 80° C. or higher. The melting point of the α-olefin copolymer (A) may be 150° C. or lower, 140° C. or lower, 130° C. or lower, 120° C. or lower, 110° C. or lower, 100° C. or lower, or 90° C. or lower, and it is preferably 120° C. or lower, for example, 110° C. or lower, or 100° C. or lower. The melting point is preferably in a range of 80° C. to 150° C. from the standpoint of allowing the effects of the present disclosure to be exerted more favorably. The melting point of the α-olefin copolymer (A) can be measured in accordance with the method prescribed in JIS K7121:2012 (Testing Methods for Transition Temperatures of Plastics).

The glass transition temperature of the α-olefin copolymer (A) may be −150° C. or higher, −125° C. or higher, −100° C. or higher, −75° C. or higher, −50° C. or higher, or −25° C. or higher. The glass transition temperature of the α-olefin copolymer (A) may be 20° C. or lower, 10° C. or lower, 0° C. or lower, −10° C. or lower, or −20° C. or lower, and it is preferably 0° C. or lower, more preferably −10° C. or lower. The glass transition temperature is preferably 20° C. or lower from the standpoint of low-temperature adhesion. The glass transition temperature of the α-olefin copolymer (A) can be measured in accordance with the method prescribed in JIS K7121:2012 (Testing Methods for Transition Temperatures of Plastics).

The α-olefin copolymer (A) is typically thermoplastic. The MFR of the α-olefin copolymer (A) may be 3 g/10 min or more, 5 g/10 min or more, 7 g/10 min or more, 10 g/10 min or more, 12 g/10 min or more, or 15 g/10 min or more, and it is preferably 5 g/10 min or more, more preferably 7 g/10 min or more. The MFR of the α-olefin copolymer (A) may be 40 g/10 min or less, 30 g/10 min or less, 20 g/10 min or less, 15 g/10 min or less, or 10 g/10 min or less. When the MFR is 3 g/10 minutes or more, the melt viscosity is further reduced and the coating stability is further improved, which is preferred. The MFR can be measured in accordance with the method prescribed in JIS K7210-1:2014 (Plastics—Determination of the melt mass-flow rate (MFR) and melt volume-flow rate (MVR) of thermoplastics).

The weight-average molecular weight of the α-olefin copolymer (A) may be, for example, 40,000 or more, 50,000 or more, 75,000 or more, 100,000 or more, 200,000 or more, 300,000 or more, or 500,000 or more, and it is preferably 100,000 or more. The weight-average molecular weight of the α-olefin copolymer (A) may be 5,000,000 or less, 2,000,000 or less, 1,500,000 or less, 1,200,000 or less, 1,000,000 or less, 800,000 or less, 600,000 or less, 400,000 or less, or 200,000 or less, and it is preferably 1,000,000 or less, for example, 600,000 or less. The weight-average molecular weight is preferably 40,000 to 5,000,000 from the standpoint of allowing the effects of the present disclosure to be exerted more favorably. The weight-average molecular weight of the α-olefin copolymer (A) can be measured in accordance with the method prescribed in JIS K7252-1:2016 (Plastics—Determination of average molecular mass and molecular mass distribution of polymers using size-exclusion chromatography).

The α-olefin copolymer (A) comprises a repeating unit derived from an olefin. The α-olefin copolymer (A) may be a homopolymer, a copolymer, or a mixture thereof. The copolymer may be in the form of any of a random copolymer, a block copolymer, a graft copolymer, and the like.

Examples of the repeating unit comprised in the α-olefin copolymer (A) comprise repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

Among the above-exemplified repeating units, the α-olefin copolymer (A) preferably comprises a repeating unit derived from propylene, and may comprise, for example, both of a repeating unit derived from propylene and a repeating unit derived from other α-olefin (e.g., ethylene). In the repeating units constituting the α-olefin copolymer (A), the amount of the repeating unit derived from propylene may be 20% by mole or more, 30% by mole or more, 40% by mole or more, 50% by mole or more, 60% by mole or more, or 70% by mole or more, and it is preferably 30% by mole or more.

The α-olefin copolymer (A) is preferably polymerized using a single-site catalyst. As compared to an α-olefin copolymer polymerized using a multi-site catalyst, an α-olefin copolymer polymerized using a single-site catalyst has more uniform molecular weight distribution and crystallinity distribution and comprises a smaller amount of low-molecular-weight component; therefore, it is more preferred from the standpoint of causing less tack and making blocking less likely to occur.

Specific examples of the α-olefin copolymer (A) comprise copolymers of olefins, such as ethylene-propylene copolymers, propylene-1-butene copolymers, ethylene-1-butene copolymers, ethylene-1-octene copolymers, ethylene-1-hexene copolymers, and ethylene-propylene-1-butene copolymers, and preferred examples comprise ethylene-propylene copolymers and propylene-1-butene copolymers. These copolymers may be used singly, or in combination of two or more kinds thereof.

Examples of representative commercial products of the α-olefin copolymer (A) comprise: WINTEC Series manufactured by Japan Polypropylene Corporation, such as trade names “WINTEC WMX03”, “WINTEC WSX03”, and “WINTEC WSX03A”; TAFMER Series manufactured by Mitsui Chemicals, Inc., such as trade names “TAFMER XM-7090”, “TAFMER XM-7080”, “TAFMER XM-7070”, “TAFMER XM-5090”, “TAFMER XM-5080”, “TAFMER XM-5070”, “TAFMER BL-2491M”, and “TAFMER DF110”; VERSIFY Series manufactured by Dow Chemical Company, such as trade names “VERSIFY 3000” and “VERSIFY 4200”; and VISTAMAXX Series manufactured by Exxon Mobil Corporation, such as trade names “VISTAMAXX 3588FL”, “VISTAMAXX 3980FL”, and “VISTAMAXX 8880”. The α-olefin copolymer (A) may be used singly, or in combination of two or more kinds thereof.

### [(B) Tackifier]

The hot-melt adhesive composition of the present disclosure comprises a tackifier (B). The tackifier (B) is not particularly limited as long as it is generally used in hot-melt adhesives and the hot-melt adhesive composition intended by the present disclosure can be obtained. The tackifier (B) has an effect of providing an open time.

The softening point of the tackifier (B) may be 90° C. or higher, 100° C. or higher, 110° C. or higher, 120° C. or higher, 130° C. or higher, 140° C. or higher, or 150° C. or higher, and it is preferably 110° C. or higher, more preferably 120° C. or higher, still more preferably 130° C. or higher. The softening point of the tackifier (B) may be, for example, 220° C. or lower, 210° C. or lower, 190° C. or lower, 180° C. or lower, 170° C. or lower, 160° C. or lower, or 150° C. or lower, and it is preferably 190° C. or lower, more preferably 160° C. or lower. The softening point of the tackifier (B) is preferably in a range of 90° C. to 160° C. from the standpoint of allowing the effects of the present disclosure to be exerted more favorably. The softening point can be measured by a ring-and-ball method, specifically in accordance with JIS K6863:1994 (Testing methods for the softening point of hot-melt adhesives). When the softening point of the tackifier (B) is 160° C. or lower, the melting temperature can be further lowered and the working time can be further shortened, which is preferred.

Examples of the tackifier (B) comprise rosin resins, rosin esters, disproportionated rosin esters, hydrogenated rosin esters, polymerized rosins, aliphatic hydrocarbon resins, aliphatic aromatic copolymer resins, aromatic petroleum resins, hydrogenated petroleum resins, terpene resins, hydrogenated terpene resins, aromatic modified terpene resins, hydrogenated products of aromatic modified terpene resins, terpene phenol resins, hydrogenated terpene phenol resins, styrene resins, coumarone resins, and indene resins. Thereamong, from the standpoint of the compatibility with the α-olefin copolymer (A), preferred examples comprise hydrogenated petroleum resins, terpene resins, and terpene phenol resins. It is noted here that the tackifier (B) is distinguished from other components such as the α-olefin copolymer (A) in terms of the presence or absence of an intramolecular double bond, an intramolecular polar group, an intramolecular hydrocarbon group, and the like.

Examples of representative commercial products of the tackifier (B) comprise: ARKON Series manufactured by Arakawa Chemical Industries, Ltd., such as trade names “ARKON P-90”, “ARKON P-100”, “ARKON P-115”, “ARKON P-140”, “ARKON M-90”, “ARKON M-100”, “ARKON M-115”, and “ARKON M-135”; “I-MARV” Series manufactured by Idemitsu Kosan Co., Ltd., such as trade names “I-MARV 5-100”, “I-MARV 5-110”, “I-MARV P-100”, “I-MARV P-125”, and “I-MARV P-140”; T-REZ Series manufactured by ENEOS Materials Corporation, such as trade names “T-REZ HA103”, “T-REZ HA105”, “T-REZ HA125”, “T-REZ HB125”, and “T-REZ OP501”; YS RESIN Series and YS POLYSTER Series manufactured by Yasuhara Chemical Co., Ltd., such as trade names “YS RESIN PX1250”, “YS RESIN PX1150”, “YS RESIN PX1000”, “YS RESIN PX1150N”, “YS RESIN TO125”, “YS RESIN TO115”, “YS RESIN TO105”, “YS POLYSTER T160”, “YS POLYSTER T145”, “YS POLYSTER T130”, “YS POLYSTER T115”, “YS POLYSTER T100”, and “YS POLYSTER UH115”; and FTR Series manufactured by Mitsui Chemicals, Inc., such as trade names “FTR6100”, “FTR6110”, and “FTR6125”. The tackifier (B) may be used singly, or in combination of two or more kinds thereof. Further, a tackifier having a softening point of lower than 90° C. may be blended within a range that does not deteriorate the desired physical properties.

### [(C) Plasticizer]

The hot-melt adhesive composition of the present disclosure comprises a plasticizer (C). The plasticizer (C) is not limited as long as it is generally used in hot-melt adhesives and the hot-melt adhesive composition intended by the present disclosure can be obtained. Examples of the plasticizer (C) comprise oily substances, such as chain alkyl group-containing low-molecular-weight compounds and olefin oligomers. The plasticizer (C) can reduce the viscosity of the hot-melt adhesive to improve the coatability and the wettability to an adherend.

The weight-average molecular weight of the plasticizer (C) may be 100 or more, 300 or more, 500 or more, or 1,000 or more. The weight-average molecular weight of the plasticizer (C) may be, for example, less than 20,000, 16,000 or less, 12,000 or less, 5,000 or less, or 3,000 or less, and it is preferably 12,000 or less. The weight-average molecular weight is preferably 100 or more and less than 20,000 from the standpoint of allowing the effects of the present disclosure to be exerted more favorably. The weight-average molecular weight can be measured in accordance with the method prescribed in JIS K7252-1:2016 (Plastics—Determination of average molecular mass and molecular mass distribution of polymers using size-exclusion chromatography).

The plasticizer (C) may have a pour point of, for example, −50° C. or higher, −40° C. or higher, −30° C. or higher, or −20° C. or higher, and 0° C. or lower, −10° C. or lower, −20° C. or lower, or −30° C. or lower. When the pour point is −50° C. to 0° C., the plasticizer (C) can exert an advantageous effect that plasticization is attained even at a low temperature. The pour point can be measured in accordance with the method prescribed in JIS K2269:1987 (Testing Methods for Pour Point and Cloud Point of Crude Oil and Petroleum Products).

Examples of the plasticizer (C) comprise liquid paraffin, process oils, phthalic acid-based plasticizers, butene oligomers, butadiene oligomers, liquid ethylene-propylene oligomers, and liquid rubbers; however, from the standpoint of compatibility, the plasticizer (C) is preferably a butene oligomer or a liquid ethylene-propylene oligomer.

Examples of representative commercial products of the plasticizer (C) comprise: NISSEKI POLYBUTENE Series manufactured by ENEOS Materials Corporation, such as trade names “NISSEKI POLYBUTENE LV-7”, “NISSEKI POLYBUTENE LV-9”, “NISSEKI POLYBUTENE LV-100”, “NISSEKI POLYBUTENE HV-15”, “NISSEKI POLYBUTENE HV-35”, “NISSEKI POLYBUTENE HV-50”, and “NISSEKI POLYBUTENE HV-100”; NOF POYBUTENE Series manufactured by NOF Corporation, such as trade names “NOF POLYBUTENE ON”, “NOF POLYBUTENE 015N”, “NOF POLYBUTENE 3N”, “NOF POLYBUTENE ION”, “NOF POLYBUTENE 30N”, and “NOF POLYBUTENE 200N”; and LUCANT Series manufactured by Mitsui Chemicals, Inc., such as trade names “LUCANT LX004”, “LUCANT LX010”, “LUCANT LX020”, “LUCANT LX100”, “LUCANT LX200”, “LUCANT LX400”, “LUCANT LX900Z”, “LUCANT A-5515”, and “LUCANT A-5260”. The plasticizer (C) may be used singly, or in combination of two or more kinds thereof.

### [(D) Polypropylene-Based Wax]

The hot-melt adhesive composition of the present disclosure may contain a polypropylene-based wax (D). The polypropylene-based wax (D) refers to a wax having a repeating unit derived from propylene, and is not particularly limited as long as it is generally used in hot-melt adhesive compositions. The polypropylene-based wax (D) generally has a low molecular weight (e.g., a weight-average molecular weight of less than 40,000), and can further reduce the viscosity of the hot-melt adhesive composition and thereby impart the hot-melt adhesive composition with superior coatability and wettability to an adherend. In addition, the polypropylene-based wax (D) further increases the crystallinity of the α-olefin copolymer (A) and the softening point of the hot-melt adhesive composition, and can thereby further enhance the heat resistance.

The polypropylene-based wax (D) has a softening point of, for example, 90° C. or higher, 100° C. or higher, 110° C. or higher, 120° C. or higher, 130° C. or higher, 140° C. or higher, or 150° C. or higher, preferably 110° C. or higher, more preferably 120° C. or higher, still more preferably 130° C. or higher. The softening point of the polypropylene-based wax (D) may be, for example, 220° C. or lower, 210° C. or lower, 190° C. or lower, 180° C. or lower, 170° C. or lower, 160° C. or lower, or 150° C. or lower, and it is preferably 190° C. or lower, more preferably 160° C. or lower. The softening point is preferably 90° C. to 160° C. from the standpoint of allowing the effects of the present disclosure to be exerted more favorably. The softening point can be measured by a ring-and-ball method, specifically in accordance with JIS K6863:1994 (Testing methods for the softening point of hot-melt adhesives). When the softening point of the polypropylene-based wax (D) is 160° C. or lower, the melting temperature can be further lowered and the working time can be further shortened, which is preferred.

The weight-average molecular weight of the polypropylene-based wax (D) may be, for example, 3,000 or more, 5,000 or more, or 7,000 or more, and it is preferably 3,000 or more. The weight-average molecular weight of the polypropylene-based wax (D) may be, for example, less than 40,000, 35,000 or less, 30,000 or less, 20,000 or less, or 10,000 or less, and it is preferably 20,000 or less. The weight-average molecular weight is preferably 3,000 or more and less than 40,000 from the standpoint of allowing the effects of the present disclosure to be exerted more favorably. The weight-average molecular weight can be measured in accordance with the method prescribed in JIS K7252-1:2016 (Plastics—Determination of average molecular mass and molecular mass distribution of polymers using size-exclusion chromatography).

The polypropylene-based wax (D) may also comprise a repeating unit other than the repeating unit derived from propylene, for example, a repeating unit derived from an α-olefin. The polypropylene-based wax (D) may be a low-molecular-weight polyolefin, particularly a low-molecular-weight α-olefin-based polymer. The polypropylene-based wax (D) may be a homopolymer, a copolymer, a pyrolysis product of a homopolymer, a pyrolysis product of a copolymer, or a mixture thereof. The copolymer may be in the form of any of a random copolymer, a block copolymer, a graft copolymer, and the like.

Examples of the repeating unit that is comprised in the polypropylene-based wax (D) in addition to the repeating unit derived from propylene comprise repeating units derived from ethylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

In the repeating units constituting the polypropylene-based wax (D), the amount of the repeating unit derived from propylene may be 20% by mole or more, 30% by mole or more, 40% by mole or more, 50% by mole or more, 60% by mole or more, or 70% by mole or more, and it is preferably 30% by mole or more.

Examples of representative commercial products of the polypropylene-based wax (D) comprise: VISCOL Series manufactured by Sanyo Chemical Industries, Ltd., such as trade names “VISCOL 660-P”, “VISCOL 550-P”, “VISCOL 440-P”, and “VISCOL 330-P”; Hi-WAX Series manufactured by Mitsui Chemicals, Inc., such as trade names “Hi-WAX 100P”, “Hi-WAX 200P”, “Hi-WAX 400P”, “Hi-WAX 800P”, “Hi-WAX 410P”, and “Hi-WAX 420P”; LICOCENE Series manufactured by Clariant Chemicals Ltd., such as trade names “LICOCENE PP6102”, “LICOCENE PP6502”, and “LICOCENE PP7502”; and L-C Series manufactured by Chusei Oil Co., Ltd., such as trade names “L-C503NC”, “L-C502NC”, “L-C501NC”, “L-C503N”, “L-C502N”, and “L-C525N”. The polypropylene-based wax (D) may be used singly, or in combination of two or more kinds thereof. Further, a wax other than a propylene-based wax may be blended within a range that does not deteriorate the desired physical properties.

### [(E) Polyolefin-Based Elastomer]

The hot-melt adhesive composition of the present disclosure may also comprise a polyolefin-based elastomer (E). The polyolefin-based elastomer (E), which is a crystalline polyolefin having a Shore A hardness of less than 80, is not particularly limited as long as the hot-melt adhesive composition intended by the present disclosure can be obtained, and the polyolefin-based elastomer (E) can impart the hot-melt adhesive composition with flexibility. Further, the polyolefin-based elastomer (E) is distinguished from other components described herein in terms of, for example, crystallinity and/or molecular weight. Typically, the polyolefin-based elastomer (E) has a weight-average molecular weight of 40,000 or more.

The Shore A hardness of the polyolefin-based elastomer (E) may be 20 or more, 30 or more, 40 or more, 50 or more, 60 or more, or 70 or more, and it is preferably 40 or more. The Shore A hardness of the polyolefin-based elastomer (E) may be less than 80, 75 or less, 70 or less, 65 or less, or 60 or less. The Shore A hardness of the polyolefin-based elastomer (E) is preferably 20 or more but less than 80 from the standpoint of allowing the effects of the present disclosure to be exerted more favorably. The Shore A hardness can be measured in accordance with the method prescribed in JIS K6253-3:2012 (Rubber, vulcanized or thermoplastic—Determination of hardness).

The melting point of the polyolefin-based elastomer (E) may be 80° C. or higher, 90° C. or higher, 100° C. or higher, or 110° C. or higher, and it is preferably 80° C. or higher. The melting point of the polyolefin-based elastomer (E) may be 180° C. or lower, 170° C. or lower, 160° C. or lower, 150° C. or lower, 140° C. or lower, 130° C. or lower, or 120° C. or lower, and it is preferably 160° C. or lower. The melting point is preferably 80° C. to 160° C. from the standpoint of allowing the effects of the present disclosure to be exerted more favorably. The melting point can be measured in accordance with the method prescribed in JIS K7121:2012 (Testing Methods for Transition Temperatures of Plastics).

The MFR of the polyolefin-based elastomer (E) may be 3 g/10 min or more, 5 g/10 min or more, 7 g/10 min or more, 10 g/10 min or more, 12 g/10 min or more, or 15 g/10 min or more, and it is preferably 5 g/10 min or more, more preferably 7 g/10 min or more. The MFR of the polyolefin-based elastomer (E) may be 40 g/10 min or less, 30 g/10 min or less, 20 g/10 min or less, 15 g/10 min or less, or 10 g/10 min or less. The MFR is preferably 3 g/10 min or more also from the standpoint of reducing the melt viscosity and improving the coating stability. The MFR can be measured in accordance with the method prescribed in JIS K7210-1:2014 (Plastics—Determination of the melt mass-flow rate (MFR) and melt volume-flow rate (MVR) of thermoplastics).

The weight-average molecular weight of the polyolefin-based elastomer (E) may be 40,000 or more, 50,000 or more, 75,000 or more, 100,000 or more, 200,000 or more, 300,000 or more, or 500,000 or more, and it is preferably 100,000 or more. The weight-average molecular weight of the polyolefin-based elastomer (E) may be 5,000,000 or less, 2,000,000 or less, 1,500,000 or less, 1,200,000 or less, 1,000,000 or less, 800,000 or less, 600,000 or less, 400,000 or less, or 200,000 or less, and it is preferably 1,000,000 or less, more preferably 600,000 or less. The weight-average molecular weight is preferably 40,000 to 600,000 from the standpoint of allowing the effects of the present disclosure to be exerted more favorably. The weight-average molecular weight can be measured in accordance with the method prescribed in JIS K7252-1:2016 (Plastics—Determination of average molecular mass and molecular mass distribution of polymers using size-exclusion chromatography).

The polyolefin-based elastomer (E) comprises a repeating unit derived from an olefin. The polyolefin-based elastomer (E) may be a homopolymer, a copolymer, or a mixture thereof. The copolymer may be in the form of any of a random copolymer, a block copolymer, a graft copolymer, and the like.

Examples of the repeating unit comprised in the polyolefin-based elastomer (E) comprise repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be comprised singly, or in combination of two or more thereof.

Among the above-described repeating units, the polyolefin-based elastomer (E) preferably comprises a repeating unit derived from propylene, and may comprise, for example, both of a repeating unit derived from propylene and a repeating unit derived from other α-olefin (e.g., ethylene). In the repeating units constituting the polyolefin-based elastomer (E), the amount of the repeating unit derived from propylene may be 20% by mole or more, 30% by mole or more, 40% by mole or more, 50% by mole or more, 60% by mole or more, or 70% by mole or more, and it is preferably 30% by mole or more.

The polyolefin-based elastomer (E) is preferably polymerized using a single-site catalyst. As compared to an α-olefin copolymer polymerized using a multi-site catalyst, an α-olefin copolymer polymerized using a single-site catalyst has more uniform molecular weight distribution and crystallinity distribution, and comprises a smaller amount of low-molecular-weight component; therefore, it is more preferred from the standpoint of causing less tack and making blocking less likely to occur.

Specific examples of the polyolefin-based elastomer (E) comprise olefin homopolymers and copolymers of olefins, such as ethylene homopolymers, propylene homopolymers, 1-butene homopolymers, ethylene-propylene copolymers, propylene-1-butene copolymers, ethylene-1-butene copolymers, ethylene-1-octene copolymers, ethylene-1-hexene copolymers, and ethylene-propylene-1-butene copolymers, and preferred examples comprise ethylene-propylene copolymers, and propylene-1-butene copolymers. These may be used singly, or in combination of two or more kinds thereof.

Examples of representative commercial products of the polyolefin-based elastomer (E) comprise: TAFMER PN Series manufactured by Mitsui Chemicals, Inc., such as trade names “TAFMER PN-2070” and “TAFMER PN-3560”; INFUSE Series manufactured by Dow Chemical Company, such as trade names “INFUSE 9807”, “INFUSE 9817”, and “INFUSE 9990”; and VISTAMAXX Series manufactured by Exxon Mobil Corporation, such as trade names “VISTAMAXX 6502” and “VISTAMAXX 6202”. The polyolefin-based elastomer (E) may be used singly, or in combination of two or more kinds thereof.

### [(F) Antioxidant]

The hot-melt adhesive composition of the present disclosure may also comprise an antioxidant (F). By incorporating the antioxidant (F), the thermal stability is further improved, which may be preferred from the standpoint of allowing the effects of the present disclosure to be exerted favorably.

Examples of the antioxidant (F) comprise hindered phenols, polyphenols, bisphenols, phosphates, thioethers, hydrotalcites, benzimidazoles, and aromatic secondary amines.

Examples of representative commercial products of the antioxidant (F) comprise: IRGANOX Series manufactured by BASF, Ltd., such as trade names “IRGANOX 1010”, “IRGANOX 1035”, “IRGANOX 1076”, “IRGANOX 1098”, “IRGANOX 1330”, “IRGANOX 245”, “IRGANOX 259”, “IRGANOX 3114”, “IRGANOX 565”, and “IRGAFOS 168”; and ADK STAB Series manufactured by ADEKA Corporation, such as trade names “ADK STAB AO-20”, “ADK STAB AO-30”, “ADK STAB AO-40”, “ADK STAB AO-50”, “ADK STAB AO-60”, “ADK STAB AO-80”, “ADK STAB AO-330”, “ADK STAB PEP-8”, “ADK STAB PEP-36”, “ADK STAB HP-10”, “ADK STAB 2112”, and “ADK STAB AO-412S”. The antioxidant (F) may be used singly, or in combination of two or more kinds thereof.

### [(G) Inorganic Filler]

The hot-melt adhesive composition of the present disclosure may also comprise an inorganic filler (G). By adding the inorganic filler (G), the adhesion, the dripping properties, the specific gravity, and the like can be adjusted.

Examples of the inorganic filler (G) comprise calcium carbonates (heavy calcium carbonate, surface-untreated calcium carbonate, surface-treated calcium carbonate (e.g., fatty acid-treated calcium carbonate), and needle-like crystalline calcium carbonate), silica (e.g., fumed silica, hydrophobic silica, and precipitating silica), talc, mica (isinglass), clay, chrysotile, wollastonite, carbon black, graphite, balloons (e.g., shirasu balloon, glass balloon, and silica balloon), inorganic fibers (e.g., glass fibers and metal fibers), titanium oxide, aluminum oxide, aluminum borate, silicon carbide, silicon nitride, potassium titanate, magnesium borate, titanium diboride, aluminum flakes, aluminum powder, and iron powder. The inorganic filler (G) may be used singly, or in combination of two or more kinds thereof.

### [(H) Other Components]

In addition to the above-described components, if necessary, the hot-melt adhesive composition of the present disclosure may further comprise other components (H). Examples of the other components (H) comprise: colorants (e.g., red iron oxide, titanium oxide, other coloring pigments, and dyes); organic solvents (e.g., methanol, ethanol, isopropyl alcohol, butanol, acetone, methyl ethyl ketone, ligroin, ethyl acetate, tetrahydrofuran, n-hexane, heptane, and isoparaffin-based high-boiling-point solvents); adhesives (e.g., silane coupling agents, such as vinyltrimethoxysilane, vinyltriethoxysilane, aminosilane, mercaptosilane, and epoxysilane; and epoxy compounds, such as glycidyl ether having a polyoxyalkylene skeleton); vulcanization accelerators (e.g., guanidines, aldehyde-amines, aldehyde-ammonias, thiazoles, sulfenamides, thioureas, thiurams, dithiocarbamates, and xanthates); vulcanization aids (e.g., long-chain fatty acids having 12 or more carbon atoms, such as stearic acid, oleic acid, and palmitic acid; and metal oxides, such as zinc oxide, magnesium oxide, and lead oxide); UV absorbers/light stabilizers (e.g., benzotriazoles and hindered amines); thixotropic agents (e.g., colloidal silica, organic bentonite, fatty acid amides, and hydrogenated castor oil); and resins and polymer components other than the above-described ones (e.g., thermosetting resins and thermoplastic resins). These components may be used singly, or in combination of two or more kinds thereof.

The hot-melt adhesive composition of the present disclosure may be of a solvent-free type, and does not have to comprise a solvent.

The hot-melt adhesive composition of the present disclosure may be of a non-reactive type, and does not have to comprise a reactive additive.

### [Formulation]

The amount of the α-olefin copolymer (A) may be 25% by mass or more, 30% by mass or more, 35% by mass or more, 40% by mass or more, 45% by mass or more, or 50% by mass or more, with respect to 100% by mass of the hot-melt adhesive composition, and it is preferably 35% by mass or more. The amount of the α-olefin copolymer (A) may be 75% by mass or less, 70% by mass or less, 65% by mass or less, 60% by mass or less, 55% by mass or less, or 50% by mass or less, with respect to 100% by mass of the hot-melt adhesive composition, and it is preferably 55% by mass or less.

The amount of the tackifier (B) may be 20% by mass or more, 25% by mass or more, 30% by mass or more, 35% by mass or more, 40% by mass or more, 45% by mass or more, 50% by mass or more, or 55% by mass or more, with respect to 100% by mass of the hot-melt adhesive composition, and it is preferably 30% by mass or more, more preferably 35% by mass or more. The amount of the tackifier (B) may be 65% by mass or less, 60% by mass or less, 55% by mass or less, 50% by mass or less, 45% by mass or less, or 40% by mass or less, with respect to 100% by mass of the hot-melt adhesive composition, and it is preferably 50% by mass or less.

The amount of the plasticizer (C) may be 2.5% by mass or more, 5% by mass or more, 7.5% by mass or more, 10% by mass or more, 12.5% by mass or more, 15% by mass or more, 17.5% by mass or more, or 20% by mass or more, with respect to 100% by mass of the hot-melt adhesive composition, and it is preferably 2.5% by mass or more, more preferably 5% by mass or more. The amount of the plasticizer (C) may be 20% by mass or less, 17.5% by mass or less, 15% by mass or less, 12.5% by mass or less, 10% by mass or less, 7.5% by mass or less, or 5% by mass or less, with respect to 100% by mass of the hot-melt adhesive composition, and it is preferably 15% by mass or less, more preferably 12.5% by mass or less.

The amount of the polypropylene-based wax (D) may be 2.5% by mass or more, 5% by mass or more, 7.5% by mass or more, 10% by mass or more, 12.5% by mass or more, 15% by mass or more, 17.5% by mass or more, or 20% by mass or more, with respect to 100% by mass of the hot-melt adhesive composition, and it is preferably 2.5% by mass or more, more preferably 5% by mass or more. The amount of the polypropylene-based wax (D) may be 20% by mass or less, 17.5% by mass or less, 15% by mass or less, 12.5% by mass or less, 10% by mass or less, 7.5% by mass or less, or 5% by mass or less, with respect to 100% by mass of the hot-melt adhesive composition, and it is preferably 15% by mass or less, more preferably 12.5% by mass or less.

The amount of the polyolefin-based elastomer (E) may be 2.5% by mass or more, 5% by mass or more, 7.5% by mass or more, 10% by mass or more, 12.5% by mass or more, 15% by mass or more, 17.5% by mass or more, or 20% by mass or more, with respect to 100% by mass of the hot-melt adhesive composition, and it is preferably 2.5% by mass or more, more preferably 5% by mass or more. The amount of the polyolefin-based elastomer (E) in the hot-melt adhesive composition may be 20% by mass or less, 17.5% by mass or less, 15% by mass or less, 12.5% by mass or less, 10% by mass or less, or 7.5% by mass or less, or 5% by mass or less, and it is preferably 15% by mass or less, more preferably 12.5% by mass or less.

The amount of the antioxidant (F) may be 0.01% by mass or more, 0.05% by mass or more, 0.1% by mass or more, 0.25% by mass or more, 0.5% by mass or more, 0.75% by mass or more, or 1% by mass or more, with respect to 100% by mass of the hot-melt adhesive composition, and it is preferably 0.1% by mass or more. The amount of the antioxidant (F) in the hot-melt adhesive composition may be 5% by mass or less, 4% by mass or less, 3% by mass or less, 2% by mass or less, or 1% by mass or less, and it is preferably 1% by mass or less.

The amount of the inorganic filler (G) may be 1% by mass or more, 2.5% by mass or more, 5% by mass or more, 7.5% by mass or more, 10% by mass or more, 12.5% by mass or more, or 15% by mass or more, with respect to 100% by mass of the hot-melt adhesive composition, and it is preferably 2.5% by mass or more, more preferably 5% by mass or more. The amount of the inorganic filler (G) in the hot-melt adhesive composition may be 30% by mass or less, 25% by mass or less, 20% by mass or less, 15% by mass or less, 10% by mass or less, or 5% by mass or less.

The amount of the other components (H) in the hot-melt adhesive composition of the present disclosure may be selected as appropriate in accordance with the respective components. A total amount of the other components (H) may be 0.1% by mass or more, 0.2% by mass or more, 0.5% by mass or more, 1% by mass or more, 2.5% by mass or more, or 5% by mass or more, with respect to 100% by mass of the hot-melt adhesive composition. A total amount of the other components (H) may be 30% by mass or less, 25% by mass or less, 20% by mass or less, 15% by mass or less, 10% by mass or less, 7.5% by mass or less, or 5% by mass or less, 2.5% by mass or less, or 1% by mass or less, with respect to 100% by mass of the hot-melt adhesive composition, and it is preferably 20% by mass or less, more preferably 10% by mass or less. The amount of each of the other components (H) may be 0.01% by mass or more, 0.05% by mass or more, 0.1% by mass or more, 0.3% by mass or more, 0.5% by mass or more, 0.75% by mass or more, 1% by mass or more, or 2.5% by mass or more. Further, the amount of each of the other components (H) may be 10% by mass or less, 7.5% by mass or less, 5% by mass or less, 2.5% by mass or less, or 1% by mass or less.

### [Physical Properties]

The hot-melt adhesive composition of the present disclosure may have a melt viscosity at 180° C., which is a common coating temperature of a hot-melt adhesive, of 5,000 mPa·s or more, 7,500 mPa·s or more, 10,000 mPa·s or more, 12,000 mPa·s or more, 15,000 mPa·s or more, 20,000 mPa·s or more, or 25,000 mPa·s or more, and the melt viscosity at 180° C. is preferably 7,500 mPa·s or more, more preferably 10,000 mPa or more. The hot-melt adhesive composition of the present disclosure may have a melt viscosity at 180° C., which is a common coating temperature of a hot-melt adhesive, of 200,000 mPa·s or less, 150,000 mPa·s or less, 100,000 mPa·s or less, 50,000 mPa·s or less, 30,000 mPa·s or less, or 20,000 mPa·s or less, and the melt viscosity at 180° C. is preferably 150,000 mPa·s or less, more preferably 100,000 mPa·s or less. When the melt viscosity at 180° C. is 5,000 mPa·s to 200,000 mPa·s, dripping, coating unevenness, and the like are less likely to occur at the time of applying the hot-melt adhesive composition to an adherend, which is preferred. The melt viscosity is a value measured using a parallel plate-type rheometer (MCR102e, manufactured by Anton Paar GmbH) under the conditions of a temperature of 180° C., a shear rate of 4.3 sec⁻¹, and a gap of 0.5 mm.

### [Open Time]

According to prior art documents, such as “3A of Pressure-Sensitive Adhesion Technology Focusing on Reliability of Pressure-Sensitive Adhesive Products and Design of Pressure-Sensitive Adhesives” (publisher: REALIZE Science & Engineering, 2006) and “Pressure-Sensitive Adhesives and Adhesiveness Physical Properties of the same” (publisher: Journal of the Society of Rubber Science and Technology, Japan, Vol. 69, No. 12, 1996), the Dahlquist criterion is known in the field of pressure-sensitive adhesives, and it states that the storage elastic modulus G′ measured at a frequency of 1 Hz must be less than 3.3×10⁵ Pa in order for a pressure-sensitive adhesive to exhibit adhesiveness. In the viscoelastic behavior of the hot-melt adhesive composition of the present disclosure when rapidly cooled from 170° C. to 20° C. at a rate of 30° C./min and then maintained at 20° C., the time required for the storage elastic modulus G′ to be 3.3×10⁵ Pa or more after the temperature reaches 20° C. is defined as the period in which bonding with a substrate is possible, i.e., “open time”. The open time of the hot-melt adhesive composition of the present disclosure may be 3 minutes or longer, 4 minutes or longer, 5 minutes or longer, 6 minutes or longer, 7 minutes or longer, 8 minutes or longer, 9 minutes or longer, 10 minutes or longer, 15 minutes or longer, or 20 minutes or longer, and it is preferably 10 minutes or longer, more preferably 15 minutes or longer. The open time of the hot-melt adhesive composition of the present disclosure may be 30 minutes or shorter, 25 minutes or shorter, 20 minutes or shorter, 15 minutes or shorter, 10 minutes or shorter, 9 minutes or shorter, 8 minutes or shorter, 7 minutes or shorter, 6 minutes or shorter, or 5 minutes or shorter, and it is preferably 30 minutes or shorter, more preferably 25 minutes or shorter. The storage elastic modulus G′ is a value measured using a parallel plate-type rheometer (MCR102e, manufactured by Anton Paar GmbH) under the conditions of a frequency of 1 Hz, a strain of 1%, and a gap of 1 mm.

In the viscoelastic behavior of the hot-melt adhesive composition of the present disclosure when rapidly cooled from 170° C. at a rate of 30° C./min and then maintained at 20° C., the storage elastic modulus G′ measured at the time when the temperature reaches 20° C. (measurement time: 5 minutes) is preferably 3.3×10⁵ Pa or less. In the viscoelastic behavior of the hot-melt adhesive composition of the present disclosure when rapidly cooled from 170° C. at a rate of 30° C./min and then maintained at 20° C., the storage elastic modulus G′ measured at the time of 3 minutes after the temperature reaches 20° C. (measurement time: 8 minutes) is preferably 3.3×10⁵ Pa or less. The storage elastic modulus G′ is a value measured using a parallel plate-type rheometer (MCR102e, manufactured by Anton Paar GmbH) under the conditions of a frequency of 1 Hz, a strain of 1%, and a gap of 1 mm.

### <Method of Producing Hot-Melt Adhesive Composition>

The hot-melt adhesive composition of the present disclosure can be produced by mixing the components (A) to (C). The hot-melt adhesive composition can be produced by, for example, mixing the components (A) to (C) along with, if necessary, other components, all at once using a heat-mixing stirrer.

### <Bonded Body and Production Method Thereof>

The bonded body of the present disclosure comprises: a first substrate; and a second substrate bonded to the first substrate via a hot-melt adhesive layer formed from a hot-melt adhesive composition.

A production method of the bonded body may comprise: a coating step of applying the hot-melt adhesive composition of the present disclosure to one surface of a first substrate to form a hot-melt adhesive layer; and a bonding step of bonding the first substrate with a second substrate via the hot-melt adhesive layer. The production method may further comprise a curing step of crystallizing the hot-melt adhesive layer.

### [Substrate]

Substrates used as the first and the second substrates are not particularly limited, and examples thereof comprise substrates made of, for example: woody materials; plastic materials, such as polyolefins, polyvinyl chlorides, polyurethanes, polyesters, and epoxy resins; foams of the aforementioned plastic materials; rubber materials, such as natural rubber and synthetic rubber; metal materials, such as aluminum, iron, and stainless steel; and inorganic materials, such as ceramics. The shape of each substrate is also not particularly limited, and each substrate may have the shape of a sheet, a foil, a plate, a molded body, or the like. The substrates may each consist of a single kind of material, or may be composed of two or more kinds of materials. The material of the surface of the substrate on which the adhesive layer is formed is preferably a non-metal material, more preferably any of the above-described resins, still more preferably a polyolefin, particularly a polypropylene.

### [Coating Step]

In the coating step, as a method of applying the hot-melt adhesive composition to the substrate, various hot-melt applicators can be used and, for example, a method using a spray gun, a comma coater, a die coater, a roll coater, or the like may be employed. When applying the hot-melt adhesive composition to the substrate, the hot-melt adhesive composition is usually melted by heating at a temperature of 140° C. to 200° C., and can be applied in a molten state. The hot-melt adhesive composition may be applied to a release film or a release paper and then thermally transferred to another substrate before use. After the application, the resulting hot-melt adhesive layer may be solidified on the substrate by cooling. A precoated substrate (adhesive layer-containing substrate) obtained after the coating step may be directly used in the subsequent molding step, or may be stored before being used in the subsequent step.

### [Bonding Step]

In the bonding step, if necessary, the hot-melt adhesive layer may be heat-activated and melted again. Examples of a heat activation means comprise, but are not particularly limited to, methods using heat, ultrasonic waves, high-frequency waves, or microwaves. This re-activation is preferably performed immediately before compression bonding of the precoated substrate and the second substrate. The precoated substrate and the second substrate are compression-bonded before the surface of the hot-melt adhesive composition layer is solidified. Examples of a compression bonding method comprise, but are not particularly limited to, a compression molding method and a vacuum molding method. The second substrate may or may not be heated. When the hot-melt adhesive layer is in a re-activated state, the second substrate does not have to be heated at the time of the compression bonding; however, if necessary, the second substrate may be heated simultaneously with compression.

The temperature of the heat activation may be, for example, 100° C. to 200° C., and it is preferably 100° C. to 180° C., more preferably 120° C. to 160° C., in terms of the surface temperature of the hot-melt adhesive layer. The pressure during the compression bonding that relates to bonding of the first substrate and the second substrate may be, for example, 0.01 to 0.50 MPa, and it is preferably 0.01 MPa to 0.20 MPa, more preferably 0.01 MPa to 0.10 MPa. The time of the compression bonding may be, for example, 1 second to 300 seconds, and it is preferably 1 second to 60 seconds, more preferably 10 seconds to 30 seconds.

The temperature of the second substrate is preferably 30° C. to 60° C., more preferably 40° C. to 50° C., in terms of the surface temperature. A heating method is not particularly limited and, for example, a hot-air heater, such as a hot air circulation-type oven, a far-infrared oven, or a dryer, may be used. By heating the second substrate, when the hot-melt adhesive comes into contact with the second substrate, crystallization of the hot-melt adhesive on the substrate surface can be temporarily inhibited, so that the substrate wettability is improved. An improvement in the substrate wettability leads to stable adhesive performance.

### <Automobile Interior Material and Production Method Thereof>

### [Automobile Interior Material]

The automobile interior material of the present disclosure comprises: a molded article for automobile interior; and a surface material for automobile interior (hereinafter, also referred to as “surface material”), which is bonded to the above-described molded article for automobile interior via a hot-melt adhesive layer formed from the hot-melt adhesive composition of the present disclosure. The surface material may be derived from a hot-melt adhesive layer-containing surface material (precoated surface material). Examples of the automobile interior material comprise door trims, instrument panels, headliners, rear trays, and pillars.

The material of the molded article for automobile interior is not particularly limited as long as it is a material that is used in automobile interior materials, and examples thereof comprise: woody materials, such as paper and wood; plastic materials, such as polyolefins (e.g., polypropylenes, polyethylenes, and ethylene-propylene copolymers), polyvinyl chlorides, polyurethanes, polyesters, epoxy resins, nylon, polyesters, polycarbonates, polyurethanes, acryl, ABS, and PCABS; rubber materials, such as natural rubber and synthetic rubber; metal materials, such as aluminum, iron, and stainless steel; and inorganic materials, such as ceramics. The molded article for automobile interior may consist of a single kind of material, or may be composed of two or more kinds of materials. The material of the surface of the molded article for automobile interior on which the adhesive layer is formed is preferably any of the above-described materials of the molded article for automobile interior, which is a non-metal material, more preferably any of the above-described materials of the molded article for automobile interior, which is a resin, still more preferably a polyolefin, such as a polypropylene.

The surface material is not particularly limited as long as it is made of a material that is used in automobile interior materials, and examples thereof comprise: plastic sheets made of a polyolefin, a soft polyvinyl chloride, a polyurethane, or the like; foams of the aforementioned plastic materials; rubber sheets of natural rubber or synthetic rubber; fabric materials, such as woven fabrics and nonwoven fabrics; and metal foils of aluminum and the like. The surface material may consist of a single layer, or may comprise two or more layers made of the same material or different materials. Examples of the surface material that comprise two or more layers comprise sheet materials obtained by laminating one or more layers of any of the aforementioned plastic foams on one or more layers of any of the aforementioned plastic sheets, rubber sheets, fabric materials, metal foils, and the like. Examples of such laminated sheet materials comprise polyolefin foam-lined soft polyvinyl chloride sheets, polyolefin foam-lined olefin-based thermoplastic elastomer sheets, and polyurethane foam-lined fabrics. The material of the surface of the surface material on which the adhesive layer is formed is preferably any of the above-described surface materials that is a non-metal material, more preferably any of the above-described surface materials that is a resin, still more preferably a polyolefin, such as a polypropylene.

### [Method of Producing Automobile Interior Material]

A method of producing the automobile interior material of the present disclosure may be the above-described bonded body production method in which the bonded body is the automobile interior material, the first substrate is a surface material, and the second substrate is a molded article for automobile interior. Conversely, the bonded body may be the automobile interior material, the first substrate may be a molded article for automobile interior, and the second substrate may be a surface material.

The method of producing the automobile interior material may comprise, for example: the step of applying the hot-melt adhesive composition of the present disclosure to the back surface of a surface material (e.g., the surface of a foam layer of the surface material) to obtain a hot-melt adhesive layer-containing surface material (precoated surface material); and the step of re-activating the thus obtained precoated surface material using a far-infrared heater or the like, melting the hot-melt adhesive layer, and then compression-bonding the surface material with a molded article for automobile interior via the hot-melt adhesive layer. The method may further comprise the curing step of crystallizing the hot-melt adhesive layer. When thermal compression bonding is possible in the step of compression-bonding the surface material with a substrate, the re-activation using a far-infrared heater or the like may be unnecessary. It is noted here that the “back surface” of the surface material means the surface that faces the molded article for automobile interior at the time of bonding the surface material with the molded article for automobile interior.

### Examples

The present disclosure will now be described more concretely by way of Examples and Comparative Examples; however, the present disclosure is not limited thereto by any means.

The components used in Examples and Comparative Examples are shown below.

### (A) Crystalline α-Olefin Copolymer Having Shore A Hardness of 80 or More

A-1: TAFMER XM-7090 manufactured by Mitsui Chemicals, Inc. (melting point: 98° C., Shore A hardness: 97, propylene-butene copolymer)
A-2: VISTAMAXX 3588FL manufactured by Exxon Mobil Corporation (melting point: 106° C., Shore A hardness: 94, ethylene content: 4% by weight, propylene-ethylene copolymer)
A-3: VISTAMAXX 8880 manufactured by Exxon Mobil Corporation (melting point: 97° C., Shore A hardness: 84, ethylene content: 6% by weight, propylene-ethylene copolymer)

### (B) Tackifier

B-1: ARKON P140 manufactured by Arakawa Chemical Industries, Ltd. (softening point: 140° C., hydrogenated petroleum-based tackifier)
B-2: ARKON P125 manufactured by Arakawa Chemical Industries, Ltd. (softening point: 125° C., hydrogenated petroleum-based tackifier)
B-3: YS RESIN PX1250 manufactured by Yasuhara Chemical Co., Ltd. (softening point: 125° C., terpene-based tackifier)
B-4: ARKON P100 manufactured by Arakawa Chemical Industries, Ltd. (softening point: 100° C., hydrogenated petroleum-based tackifier)

### (C) Plasticizer

C-1: NISSEKI POLYBUTENE HV-100N manufactured by ENEOS Materials Corporation (pour point: −7.5° C. or lower, weight-average molecular weight: 2,500, isobutene-n-butene copolymer)
C-2: LUCANT LX020 manufactured by Mitsui Chemicals, Inc. (pour point: −10° C. or lower, weight-average molecular weight: 5,000, ethylene-propylene copolymer)

### (D) Polypropylene-Based Wax

D-1: VISCOL 660-P manufactured by Sanyo Chemical Industries, Ltd. (softening point: 145° C., weight-average molecular weight: 10,000, polypropylene wax)

### (E) Polyolefin-Based Elastomer

E-1: TAFMER PN-2070 manufactured by Mitsui Chemicals, Inc. (melting point: 140° C., Shore A hardness: 75, propylene-based elastomer)

### (F) Antioxidant

F-1: IRGANOX 1010 manufactured by BASF Ltd. (melting point: 110° C., hindered phenol-based antioxidant)
F-2: IRGAFOS 168 manufactured by BASF Ltd. (melting point: 183° C., phosphorus-based antioxidant)

### (X) Amorphous Polyolefin

X-1: VESTOPLAST 792 manufactured by Evonik Degussa GmbH (softening point: 108° C., weight-average molecular weight: 118,000, amorphous polyolefin)

### (Y) α-Olefin Homopolymer

Y-1: KOATTRO PB0800M manufactured by LyondellBasell Industries holdings B.V (melting point: 124° C., 1-butene homopolymer)

### Examples 1 to 8 and Comparative Examples 1 to 5

Hot-melt adhesive compositions of Examples 1 to 8 and Comparative Examples 1 to 5 were each obtained by mixing the components shown below in accordance with the respective formulations shown in Tables 1 and 2 at 180° C. using a mixing stirrer equipped with a heat medium jacket (a kneader manufactured by PRIMIX Corporation, HIVIS MIX 2P-1).

TABLE 1

| | | Example | | | | | | | |
|---|---|---|---|---|---|---|---|---|---|
| | | 1 | 2 | 3 | 4 | 5 | 6 | 7 | 8 |
| (A) | A-1 | 14 | 20 | | 8 | 8 | 8 | 8 | 8 |
| | A-2 | | | 14 | | | | | |
| | A-3 | 32 | 32 | 32 | 32 | 32 | 32 | 32 | 32 |
| (E) | E-1 | | | | 6 | 6 | 6 | 6 | 6 |
| (X) | X-1 | | | | | | | | |
| (Y) | Y-1 | | | | | | | | |
| (B) | B-1 | 20 | 20 | 20 | 20 | 20 | | | 20 |
| | B-2 | 20 | 20 | 20 | 20 | | 40 | | 20 |
| | B-3 | | | | | 20 | | | |
| | B-4 | | | | | | | 40 | |
| (C) | C-1 | 8 | 8 | 8 | 8 | 8 | 8 | 8 | |
| | C-2 | | | | | | | | 8 |
| (D) | D-1 | 6 | | 6 | 6 | 6 | 6 | 6 | 6 |
| (F) | F-1 | 0.25 | 0.25 | 0.25 | 0.25 | 0.25 | 0.25 | 0.25 | 0.25 |
| | F-2 | 0.25 | 0.25 | 0.25 | 0.25 | 0.25 | 0.25 | 0.25 | 0.25 |
| Total | | 100.5 | 100.5 | 100.5 | 100.5 | 100.5 | 100.5 | 100.5 | 100.5 |
| Melt viscosity | (mPa · s) | 17,000 | 64,000 | 18,000 | 18,000 | 17,000 | 18,000 | 14,000 | 16,000 |
| | 180° C. | | | | | | | | |
| Open time | (min) | VG | VG | VG | VG | VG | VG | VG | VG |
| | | >15 | >15 | 9 | 10 | 10 | 10 | 9 | 7 |
| Storage elastic modulus | (MPa) | | | | | | | | |
| At the time of reaching | 0 min | 0.03 | 0.06 | 0.03 | 0.04 | 0.03 | 0.03 | 0.02 | 0.03 |
| 20° C. | | | | | | | | | |
| After reaching 20° C. | 1 min | 0.06 | 0.10 | 0.05 | 0.05 | 0.05 | 0.06 | 0.04 | 0.03 |
| | 2 min | 0.08 | 0.12 | 0.07 | 0.07 | 0.07 | 0.09 | 0.06 | 0.09 |
| | 3 min | 0.10 | 0.14 | 0.10 | 0.0 | 0.09 | 0.11 | 0.08 | 0.11 |
| | 4 min | 0.12 | 0.15 | 0.12 | 0.11 | 0.11 | 0.13 | 0.09 | 0.14 |
| | 5 min | 0.13 | 0.16 | 0.14 | 0.12 | 0.12 | 0.14 | 0.11 | 0.17 |
| | 6 min | 0.14 | 0.17 | 0.16 | 0.13 | 0.14 | 0.16 | 0.14 | 0.21 |
| | 7 min | 0.16 | 0.18 | 0.19 | 0.14 | 0.15 | 0.17 | 0.17 | 0.26 |
| | 8 min | 0.17 | 0.18 | 0.23 | 0.16 | 0.17 | 0.19 | 0.22 | 0.34 |
| | 9 min | 0.18 | 0.18 | 0.28 | 0.17 | 0.19 | 0.21 | 0.29 | 0.45 |
| | 10 min | 0.20 | 0.19 | 0.34 | 0.19 | 0.22 | 0.24 | 0.39 | 0.62 |
| | 15 min | 0.29 | 0.19 | 1.20 | 0.34 | 0.45 | 0.51 | 1.30 | 2.60 |
| Initial creep | (mm) | 0 | 0 | 0 | 0 | 0 | 0 | 0 | 1 |
| | | | | | | | | | AF100 |
| Bonding strength | (N/25 mm) | 11 | 11 | 11 | 11 | 11 | 11 | 11 | 11 |
| | | MB 100 | MB100 | MB100 | MB100 | MB100 | MB100 | MB100 | MB100 |
| Heat-resistant creep | (mm) | 0 | 0 | 0 | 0 | 0 | 0 | 5 | 5 |
| | | | | | | | | AF100 | AF100 |

TABLE 2

| | | Comparative Example | | | | |
|---|---|---|---|---|---|---|
| | | 1 | 2 | 3 | 4 | 5 |
| (A) | A-1 | | | 14 | 14 | |
| | A-2 | | | | | |
| | A-3 | | | 32 | 32 | |
| (E) | E-1 | 46 | | | | 17 |
| (X) | X-1 | | 46 | | | |
| (Y) | Y-1 | | | | | 20 |
| (B) | B-1 | 20 | 20 | | 20 | 37 |
| | B-2 | 20 | 20 | | 20 | |
| | B-3 | | | | | |
| | B-4 | | | | | |
| (C) | C-1 | 8 | 8 | 27 | | 12 |
| | C-2 | | | | | |
| (D) | D-1 | 6 | 6 | 27 | 14 | 14 |
| | F-1 | 0.25 | 0.25 | 0.25 | 0.25 | 0.5 |
| (F) | F-2 | 0.25 | 0.25 | 0.25 | 0.25 | 0.5 |
| Total | | 100.5 | 100.5 | 100.5 | 100.5 | 101 |
| Melt viscosity | (mPa · s) | >100,000 | 33,000 | not | 18,000 | 45,000 |
| | 180° C. | | | kneadable | | |
| Open time | (min) | — | G | — | P | P |
| | | — | 4 | — | 0 | 2 |
| Storage elastic modulus | (MPa) | | | | | |
| At the time of reaching | 0 min | — | 0.05 | — | 0.98 | 0.08 |
| 20° C. | | | | | | |
| After reaching 20° C. | 1 min | — | 0.09 | — | 2.10 | 0.16 |
| | 2 min | — | 0.14 | — | 3.00 | 0.30 |
| | 3 min | — | 0.20 | — | 3.90 | 0.56 |
| | 4 min | — | 0.29 | — | 4.90 | 1.10 |
| | 5 min | — | 0.39 | — | 6.30 | 2.70 |
| | 6 min | — | 0.50 | — | 8.40 | 5.80 |
| | 7 min | — | 0.61 | — | 11.00 | 9.60 |
| | 8 min | — | 0.71 | — | 15.00 | 12.00 |
| | 9 min | — | 0.81 | — | 19.00 | 14.00 |
| | 10 min | — | 0.90 | — | 24.00 | 16.00 |
| | 15 min | — | 1.20 | — | 37.00 | 190.00 |
| Initial creep | (mm) | not | >50 | — | bonding | bonding |
| | | coatable | CF100 | | failure | failure |
| Bonding strength | (N/25 mm) | not | 11 | — | bonding | bonding |
| | | coatable | MB100 | | failure | failure |
| Heat-resistant creep | (mm) | not | >50 | — | bonding | bonding |
| | | coatable | CF100 | | failure | failure |

Using the hot-melt adhesive compositions of Examples 1 to 8 and Comparative Examples 1 to 5, the melt viscosity was measured and the open time was evaluated as described below. Further, bonding test samples were prepared, and the initial creep, the bonding strength, and the heat-resistant creep were evaluated as described below.

### [Melt Viscosity]

The melt viscosity of each adhesive composition was measured using a parallel plate-type rheometer (MCR102e, manufactured by Anton Paar GmbH) under the conditions of a temperature of 180° C., a shear rate of 4.3 sec-, and a gap of 0.5 mm. The results thereof are shown in Tables 1 and 2.

### [Open Time]

Using a parallel plate-type rheometer (MCR102e, manufactured by Anton Paar GmbH), the storage elastic modulus G′ of each adhesive composition was measured under the conditions of a frequency of 1 Hz, a strain of 1%, and a gap of 1 mm when the adhesive composition was cooled from 170° C. to 20° C. at a rate of 30° C./min and then maintained at 20° C. for 15 minutes after reaching 20° C. The time required for the storage elastic modulus G′ to be 3.3×10⁵ Pa or more after the temperature reached 20° C. was verified. The results thereof are shown in Tables 1 and 2.

Very Good (VG): 6 minutes or longer (measured time comprising the cooling step: 11 minutes or longer)

Good (G): 3 minutes or longer but shorter than 6 minutes (measured time comprising the cooling step: 8 minutes or longer and shorter than 11 minutes)

Poor (P): shorter than 3 minutes (measured time comprising the cooling step: shorter than 8 minutes)

### [Preparation of Bonding Test Sample 1]

The above-obtained adhesive compositions were each applied to the surface of a surface material (nylon fabric/soft polyurethane foam/nonwoven fabric, total thickness: 3 mm) at 180° C. using a roll coater such that an adhesive layer was formed in an amount of 100 g/m². Subsequently, after a lapse of 3 minutes after the application of the adhesive composition, the surface material was disposed on a PP board (thickness: 2 mm) heated to 50° C., and the resultant was pressed at 0.05 MPa for 15 seconds to obtain a laminate (bonding test sample 1).

### [Initial Creep]

After obtaining the laminate (bonding test sample 1), a load of 100 g/25 mm was applied thereto at an angle of 900 in a 60° C. atmosphere, and the peeling length (mm) after 5 minutes was measured. Further, the peeled part was visually observed. The results thereof are shown in Tables 1 and 2.
AF: Interfacial failure on the substrate side
MB: Material failure of the surface material
CF: Cohesion failure of the adhesive

The numbers after the failure state each indicate a ratio of the failure state.

### [Bonding Strength]

After curing the laminate (bonding test sample 1) at 25° C. for 24 hours, the peel strength (N/25 mm) in 1800 peeling was measured. The PP board was immobilized with a jig, and the surface material was peeled off in a pulling manner. The measurement was performed at a peeling speed of 200 mm/min. The peeled part was visually observed in the same manner as in the evaluation of the initial creep. The results thereof are shown in Tables 1 and 2.

### [Heat-Resistant Creep]

After curing the laminate (bonding test sample 1) at 25° C. for 24 hours, a load of 100 g/25 mm was applied thereto at an angle of 900 in an 80° C. atmosphere, and the peeling length (mm) after 24 hours was measured. The peeled part was visually observed in the same manner as in the evaluation of the initial creep. The results thereof are shown in Tables 1 and 2.

### [Results]

The hot-melt adhesive compositions of Examples 1 to 8 attained good melt viscosity, open time, and bonding properties.

The hot-melt adhesive composition of Comparative Example 1 had a high viscosity and caused a coating defect since it did not comprise the crystalline α-olefin copolymer (A) having a Shore A hardness of 80 or more.

In the hot-melt adhesive composition of Comparative Example 2, the creep properties were deteriorated due to the use of the amorphous polyolefin (X).

The hot-melt adhesive composition of Comparative Example 3 caused a kneading defect since it did not comprise the tackifier (B).

The hot-melt adhesive composition of Comparative Example 4 had an insufficient open time and caused a bonding failure since it did not comprise the plasticizer (C).

In the hot-melt adhesive composition of Comparative Example 5, the elastomer (E) and the 1-butene homopolymer (Y) were incorporated in place of the α-olefin copolymer (A); therefore, this hot-melt adhesive composition had an insufficient open time and caused a bonding failure.

### INDUSTRIAL APPLICABILITY

The hot-melt adhesive composition of the present disclosure exhibits good adhesion to, for example, a polyolefin substrate formed of a polypropylene or the like, and can achieve both a long open time and a high heat resistance, although it is not a reactive hot-melt adhesive composition. Further, the hot-melt adhesive composition of the present disclosure can be, without re-activation, suitably used in a process (e.g., a compression molding process) in which the hot-melt adhesive composition is applied to a surface material and then pasted together with a molded body, for example, after a long open time, and can also be suitably used as an adhesive for automobile interior.

What is claimed is:

1. A hot-melt adhesive composition, comprising:
a crystalline α-olefin copolymer (A) having a Shore A hardness of 80 or more;
a tackifier (B); and
a plasticizer (C),
wherein, in the viscoelastic behavior of the hot-melt adhesive composition when rapidly cooled from 170° C. to 20° C. at a rate of 30° C./min and then maintained at 20° C., the hot-melt adhesive composition has a storage elastic modulus (G′) of 3.3×10⁵ Pa or less as measured at a time of 3 minutes after reaching 20° C. (measurement time: 8 minutes) at a frequency of 1 Hz.

2. The hot-melt adhesive composition according to claim 1, wherein the α-olefin copolymer (A) comprises at least one selected from the group consisting of an ethylene-propylene copolymer and a propylene-butene copolymer.

3. The hot-melt adhesive composition according to claim 1, wherein the α-olefin copolymer (A) is polymerized using a single-site catalyst.

4. The hot-melt adhesive composition according to claim 1, wherein the tackifier (B) has a softening point of 100° C. or higher.

5. The hot-melt adhesive composition according to claim 1, wherein the tackifier (B) comprises at least one selected from the group consisting of a hydrogenated petroleum resin, a terpene resin, and a terpene phenol resin.

6. The hot-melt adhesive composition according to claim 1, wherein the plasticizer (C) comprises at least one selected from the group consisting of a liquid butene oligomer and a liquid ethylene-propylene oligomer.

7. The hot-melt adhesive composition according to claim 1, comprising a polypropylene-based wax (D).

8. The hot-melt adhesive composition according to claim 1, comprising a polyolefin-based elastomer (E).

9. The hot-melt adhesive composition according to claim 1, comprising an antioxidant (F).

10. The hot-melt adhesive composition according to claim 1, having a melt viscosity of 100,000 mPa·s or less at 180° C.

11. The hot-melt adhesive composition according to claim 1, which is for an automobile interior material.

12. A precoated surface material for automobile interior, comprising:
a surface material for automobile interior; and
a hot-melt adhesive layer formed from the hot-melt adhesive composition according to claim 1 on a back surface of the surface material for automobile interior.

13. An automobile interior material, comprising:
a molded article for automobile interior; and
the precoated surface material for automobile interior according to claim 12, which is bonded to the molded article for automobile interior via the hot-melt adhesive layer.

14. A method of producing a bonded body,
wherein
the bonded body comprises a first substrate, and a second substrate bonded to the first substrate via a hot-melt adhesive layer formed from the hot-melt adhesive composition according to claim 1, and
the method comprises a step of melting and applying the hot-melt adhesive composition according to claim 1 onto the first substrate, and subsequently bonding the second substrate thereto within 3 minutes.
